(19) United States
(12) Patent Application Publication
(10) Pub. No.: US 2013/0307667 A1
(43) Pub. Date: Nov. 21, 2013

(54) AUTHENTICATION SYSTEM OF PORTABLE ELECTRONIC DEVICE AND PORTABLE ELECTRONIC DEVICE USING THE SAME

(71) Applicant: ASUSTeK COMPUTER INC., Taipei (TW)

(72) Inventors: Chia-Hsin YANG, Taipei (TW); Yang-Po CHIU, Taipei (TW); Ting-Shuo YO, Taipei (TW)

(73) Assignee: ASUSTeK COMPUTER INC., Taipei (TW)

(21) Appl. No.: 13/891,905

(22) Filed: May 10, 2013

Related U.S. Application Data
(60) Provisional application No. 61/648,250, filed on May 17, 2012.

(30) Foreign Application Priority Data
Apr. 8, 2013 (TW) 102112339

(51) Int. Cl. H04B 5/00

(52) U.S. Cl. CPC H04B 5/0056
USPC 340/5.8

(57) ABSTRACT

An authentication system of a portable electronic device is disclosed. The authentication system of a portable electronic device includes a first identity recognition module, a second identity recognition module, an application module, an authentication module and a near field communication (NFC) module. The application module enables the first identity recognition module or the second identity recognition module according to a setting. The authentication module is electrically connected to the first identity recognition module and the second identity recognition module. The authentication module authenticates the first identity recognition module or the second identity recognition module which is enabled. The NFC module is electrically connected to the first identity recognition module and the second identity recognition module. The NFC module executes a corresponding function according to the first identity recognition module or the second identity recognition module which is enabled and authenticated.

### CROSS-REFERENCE TO RELATED APPLICATION

This application claims the priority benefit of U.S. provisional application serial No. 61/648,250, filed on May 17, 2012, and Taiwan application serial no. 102112339, filed on Apr. 8, 2013. The entirety of the above-mentioned patent applications are hereby incorporated by reference herein and made a part of specification.

### BACKGROUND OF THE INVENTION

1. Field of the Invention

The invention relates to an authentication system of a portable electronic device and a portable electronic device using the same and, more particularly, to an authentication system of a portable electronic device applying double modules and a portable electronic device using the same.

2. Description of the Related Art

As science technology develops, conventional cash payment is replaced by more and more advanced scientific methods. In an electronic payment system, an integrated circuit card (ICC) is usually used as a carrier for an electronic cash package. The electronic cash package stores consumable amount of the user in a chip of the ICC, and the user can consume using the money stored in the ICC.

However, the user may carry different ICCs, credit cards or automated tellermachine (ATM) cards released by different operators, which is rather inconvenient. Since users have a pursuit for a better life, various portable electronic devices, such as a mobile phone, a smart phone, a personal digital assistant, a notebook computer and a tablet computer are developed to integrate an ICC to the portable electronic device. Thus, the user can pay via the portable electronic device anywhere.

Since the payment via the portable electronic device involves sec hardware design and strategies of operators, the methods of integrating the ICC to the portable electronic device are different. Taking telecommunication manufacturers as an example, a security element including payment information is built in an issued subscriber identity module (SIM) card. Bankers prefer a secure digital (SD) card to completely hold the subscriber information. Electronic manufacturers embed the security element into the portable electronic device as a selling point.

However, if the SIM card is got from the telecommunication manufacturers, general card issuers cannot use the card by themselves, and they are limited by the telecommunication manufacturers. If the security element is embedded into the SD card, it needs further packaging, which increases manufacture cost. Furthermore, in consideration of data security and management, embedding the security element into the portable electronic device is not the best choice. Since the conventional portable electronic device cannot support multiple security element structures, it is rather inconvenient in using.

### BRIEF SUMMARY OF THE INVENTION

An authentication system of a portable electronic device includes a first identity recognition module, a second identity recognition module, an application module, an authentication module and a near field communication (NFC) module. The application module enables the first identity recognition module or the second identity recognition module according to a setting. The authentication module is electrically connected to the first identity recognition module and the second identity recognition, module and authenticates the first identity recognition module or the second identity recognition module which is enabled. The NFC module is electronically connected to the first identity recognition module and the second identity recognition module and executes a corresponding function according to the first identity recognition module or the second identity recognition module Which is enabled and authenticated.

A portable electronic device includes a first containing slot, a second containing slot and an authentication system of the electronic device. The authentication system of the electronic device includes a first identity recognition module, a second identity recognition module, an application module, an authentication module and a NFC module. The first identity recognition module is accommodated in the first containing slot. The second identity recognition module is accommodated in the second containing slot. The application module enables the first identity recognition module or the second identity recognition module according to a setting. The authentication module is electrically connected to the first identity recognition module and the second identity recognition module and authenticates the first identity recognition module or the second identity recognition module which is enabled. The NFC module is electronically connected to the first identity recognition module and the second identity recognition module and executes an electronic payment function according to the first identity recognition module or the second identity recognition module which is enabled and authenticated.

As stated above, the authentication system of the portable electronic device includes the double module authentication system and the NFC module electrically connected to each other, and the user can use different modules to execute an electronic payment function, which improves convenience in using, increases accommodating space for the ICCs of different operators and avoids troubles of changing a smart card of different operators in the portable electronic device.

Furthermore, the authentication system of the portable electronic device enables the operators to release cards without the telecommunication manufacturers and manage the user data and possible risks.

These and other features, aspects and advantages of the present invention will become better understood with regard to the following description, appended claims, and accompanying drawings.

### BRIEF DESCRIPTION OF THE DRAWINGS

FIG. 1A is a block diagram showing an authentication system of a portable electronic device in an embodiment; and

FIG. 1B is a block diagram showing a portable electronic device applying the authentication system in FIG. 1A.

### DETAILED DESCRIPTION OF THE EMBODIMENTS

A portable electronic double authentication system and a portable electronic device using the same are illustrated with relating figures, and the same symbols denote the same components.

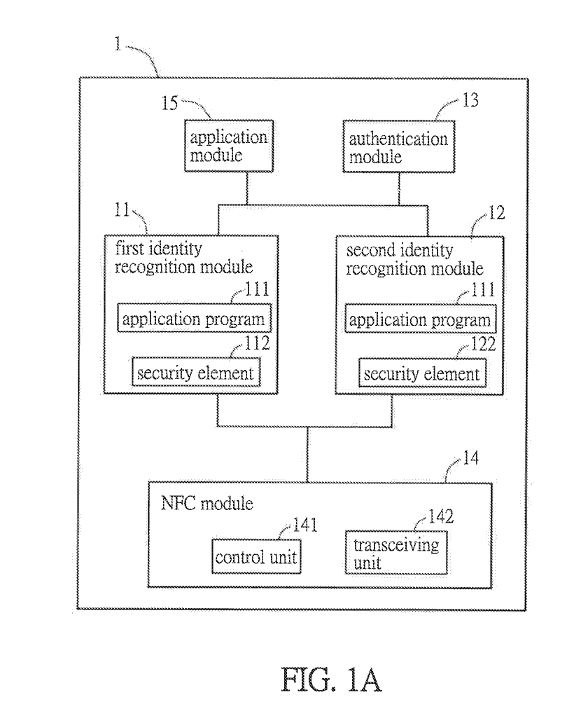

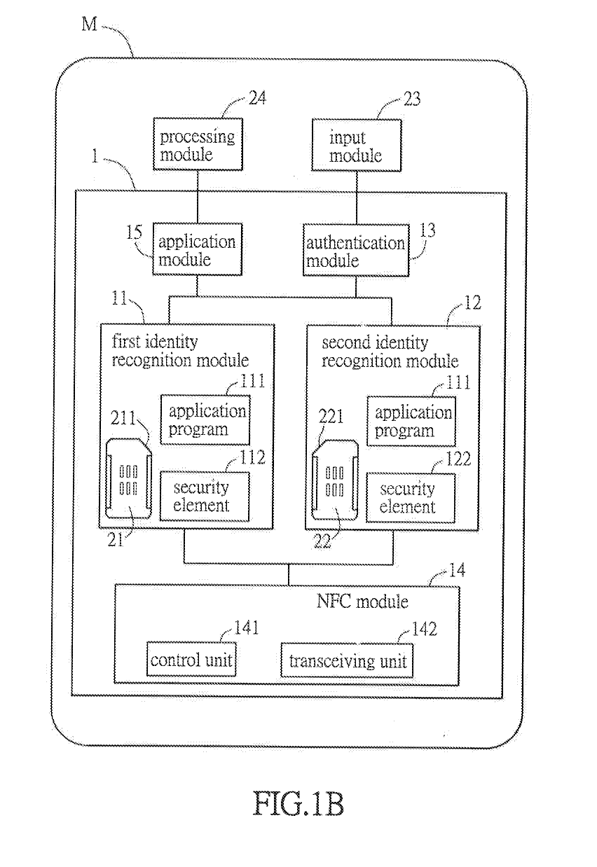

FIG. 1A is a block diagram showing an authentication system a portable electronic device in an embodiment, and FIG. 1B is a block diagram showing a portable electronic device applying the authentication system in FIG. 1A. Please refer to FIG. 1A and FIG. 1B, in the embodiment, an authentication system 1 of a portable electronic device 1 includes a first identity recognition module 11, a second identity recognition module 12, an authentication module 13, a near field communication (NFC) module 14 and an application module 15. The authentication module 13 and the NFC module 14 are electrically connected to the first identity recognition module 11 and the second identity recognition module 12.

The authentication system 1 of the portable electronic device is applied to the portable electronic device M for payment. The authentication system 1 of the portable electronic device is used for information exchange and authentication between the portable electronic device M and a remote server (not shown) via a wireless network, so as to achieve the payment function. The remote server may be an electronic bill service platform, a bank or a shop, which is not limited herein.

In the embodiment, for example, a user wants to use the authentication system 1 of the portable electronic device to pay to a remote server. The first identity recognition module 11 is accommodated in the first containing slot 21, and the first identity recognition module 11 is a subscriber identity module (SIM), and it may also be a mini SIM or a micro SIM, which is not limited herein. The first identity recognition module 11 is a SIM chip released by telecommunication manufacturers, and it is inserted to the portable electronic device M for communication.

In the embodiment, the portable electronic device M further includes the second identity recognition module 12 accommodated in a second containing slot 22. The first containing slot 21 and the second containing slot 22 are disposed adjacently, which is not limited herein. The second identity recognition module 12 is a payment identity module (PIM) chip released by a bank or an electronic bill provider, not the telecommunication manufacturers.

In the embodiment, the first identity recognition module 11 and the second identity recognition module 12 include an application program 111, respectively, to provide a port and a program for the payment. The application program may include a financial paying application program, an application program of a security access system and an ICC application program which can be encrypted, which is not limited herein. The first identity recognition module and the second identity recognition module may include more than one application program, respectively, and each of the chips has different functions for a payment.

Moreover, the first identity recognition module 11 includes a security element 112, and the second identity recognition module 12 includes a security element 122. In the embodiment, the security element 112 and 122 are connected to the application programs 111, and the security elements store payment information relating to the connected application programs. The first identity recognition module 11 can be used both in communication and payment via the security element 112. Taking the telecommunication manufacturers as an example, the SIM chip provides functions of communication and payment. The portable electronic device may only include one security element, and the first identity recognition module 11 and the second identity recognition module 12 are electronically connected to the security element to simplify the structure, which is not limited herein.

The portable electronic device M includes an input module 23. In the embodiment, the input module 23 may be a touch pad, a keyboard or a touch control panel, which is not limited herein. The user inputs a signal via the input module 23 and controls a processing module 24 to enable the application program corresponding to a pay item.

In the embodiment, the first identity recognition module 11 and the second identity recognition module 12 have the same application program 111, and particularly, the SIM chip is inserted to the first containing slot 21 and the PIM chip is inserted to the second containing slot 22. The processing module 24 further controls the application module 15 to enable one of the first identity recognition module and the second identity recognition module according to a setting. The setting may be that after the user finishes a setting according to preference, the application module 15 selects automatically, or the user selects manually via a port of the application module 15, which is not limited herein.

After the application module 15 enables the first identity recognition module 11 or the second identity recognition module 12 according to a setting, the authentication module 13 authenticates the enabled first identity recognition module 11 or the enabled second identity recognition module 12, and the authentication way may be that the enabled first identity recognition module 11 or the enabled second identity recognition 12 is encrypted and decrypted via the authentication module 13. The encryption and decryption method includes one or a combination of 3DES, advanced encryption standard (AES), RSA encryption algorithm, transport layer security (TLS) and Hash function, which is not limited herein.

After the authentication, the NFC module 14 executes a corresponding function, such as electronic payment function, according to the first identity recognition module 11 or the second identity recognition module 12 which is enabled and authenticated. The user can select the first identity recognition module 11 or the second identity recognition module 12 to pay, which means the authentication system applied to the portable electronic device M is a double payment authentication system which includes double modules. When the application module 15 enables the first identity recognition module 11, the second identity recognition module 12 is disabled, and vice versa.

The NFC module 14 includes a control unit 141 and a transceiving unit 142 connected to the control unit 141 in a wired way or a wireless way. In the embodiment, the control unit 141 is a chip having an NFC function, and the transceiving unit 142 is a transceiving antenna. The control unit 141 cooperates with the transceiving unit 142 to execute the NFC function.

The NFC module 14 applies a near-field or short-field communication technology, and the technology type of exchanged data or information is not limited. The distance range of the near-field or short-field communication is 0 to 5 m, preferably 0 to 3 m, and even preferably 0 to 50 cm. “0 m” means at least a part of two devices contact with each other. The NFC technology includes radio frequency identification (RFID) communication, short distance wireless communication, NFC, or any communication protocol based on the above three communication methods, which is not limited herein.

Protocols and technologies used by the NFC module 14 are known by persons with ordinary skills in the art, which is omitted herein.

After the SIM chip is inserted to the first containing slot 21 or the PIM chip is inserted to the second containing slot 22, the application module 15 can enable the first identity recognition module 11 or the second identity recognition module 12. If only the SIM chip is inserted to the first containing slot 21 or only the PIM chip is inserted to the second containing slot 22, the application module 15 enables the module which has a chip thereat directly. Thus, the user can select more flexibly, and when the telecommunication manufacturers and other operators have different paying mechanisms and corresponding modules, the application program of the portable electronic device can help the user to switch to an appropriate module.

The operators save cost of packaging the SD card according to the portable electronic double authentication system.

Please refer to FIG. 1B, the first containing slot 21 and the second containing slot 22 have chamfered parts 211 and 221 formed at opposite positions, respectively, and the SIM chip and the PIM chip also have chamfered parts (not shown) corresponding to the two containing slots. Circuits in the first containing slot 21 and the second containing slot 22 are consistent, the chamfered parts 211 and 221 can be used as an anti-proof mechanism to avoid that the chips are wrongly inserted.

Although the present invention has been described in considerable detail with reference to certain preferred embodiments thereof, the disclosure is not for limiting the scope. Persons having ordinary skill in the art may make various modifications and changes without departing from the scope. Therefore, the scope of the appended claims should not be limited to the description of the preferred embodiments described above.

What is claimed is:

1. An authentication system of a portable electronic device, comprising:
a first identity recognition module;
a second identity recognition module;
an application module enabling the first identity recognition module or the second identity recognition module according to a setting;
an authentication module electrically connected to the first identity recognition module and the second identity recognition module and authenticating the first identity recognition module or the second identity recognition module which is enabled; and
a near field communication (NFC) module electronically connected to the first identity recognition module and the second identity recognition module and executing a corresponding function according to the first identity recognition module or the second identity recognition module which is enabled and authenticated.

2. The authentication system of the portable electronic device according to claim 1, wherein the authentication system includes:
a security element electrically connected to the first identity recognition module or the second identity recognition module.

3. The authentication system of the portable electronic device according to claim 1, wherein the first identity recognition module is a subscriber identity module (SIM) chip and the second identity recognition module is a payment identity module (PIM) chip.

4. The authentication system of the portable electronic device according to claim 3, wherein the SIM chip and the PIM chip have a chamfered part, respectively, at opposite positions.

5. The authentication system of the portable electronic device according to claim 1, wherein the first identity recognition module is used for at least one of communication and payment functions.

6. A portable electronic device, comprising:
a first containing slot;
a second containing slot; and
an authentication system of the electronic device including:
a first identity recognition module accommodated in the first containing slot;
a second identity recognition module accommodated in the second containing slot;
an application module enabling the first identity recognition module or the second identity recognition module according to a setting;
an authentication module electrically connected to the application module, the first identity recognition module and the second identity recognition module and authenticating the first identity recognition module or the second identity recognition module which is enabled; and
a near field communication (NFC) module electronically connected to the first identity recognition module and the second identity recognition module and executing a corresponding function according to the first identity recognition module or the second identity recognition module which is enabled and authenticated.

7. The portable electronic device according to claim 6, wherein the portable electronic device further includes:
a security element electrically connected to the first identity recognition module or the second identity recognition module.

8. The portable electronic device according to claim 6, wherein the first identity recognition module is a subscriber identity module (SIM) chip and the second identity recognition module is a payment identity module (PIM) chip.

9. The portable electronic device according to claim 8, wherein the SIM chip and the PIM chip have a chamfered part, respectively, at opposite positions.

10. The portable electronic device according to claim 6, wherein the first identity recognition module is used for at least one of communication and payment functions.
